(19) United States
(12) Patent Application Publication
(10) Pub. No.: US 2008/0144882 A1
(43) Pub. Date: Jun. 19, 2008

(54) SYSTEM AND METHOD FOR DETERMINING LIKE-MINDEDNESS

(75) Inventors: Kurt Leinbach, Mesa, AZ (US); Alan T. Miller, Glendale, AZ (US)

Correspondence Address: NOBLITT & GILMORE, LLC., 4800 NORTH SCOTTSDALE ROAD, SUITE 6000, SCOTTSDALE, AZ, 85251, US

(73) Assignee: Mind Metrics, LLC

(21) Appl. No.: 11/697,009

(22) Filed: Apr. 5, 2007

Related U.S. Application Data
(60) Provisional application No. 60/870,733, filed on Dec. 19, 2006.

(51) Int. Cl. G06K 9/00

(52) U.S. Cl. 382/100; 707/10

(57) ABSTRACT

Methods and apparatus for a participant response system according to various aspects of the present invention operate in conjunction with an information system and an assessment system. The information system may store selection information in response to a first participant's selection of images from a set of candidate images. The assessment system is responsive to the information system, identifies a correlation between the selection information of the first participant and a set of comparison data.

### CROSS-REFERENCE TO RELATED APPLICATION

This application claims the benefit of U.S. Provisional Patent Application No. 60/870,733, filed Dec. 19, 2006.

### BACKGROUND OF INVENTION

As the Internet has matured, so have popular attitudes. People increasingly do not think twice about “googling” for information on any given topic, sending their hard-earned money off to a complete stranger for an offbeat item they found on an online auction, or putting their own likeness out on many popular dating web sites that dot the Internet landscape. The initial skepticism that precluded many people from entrusting the Internet early on has progressively subsided.

The increasing acceptance of the Internet and willingness to employ it in the service of finding a date, a lifelong partner, just a friend, or even modern day “penpal”, has not necessarily led to viable solutions. Online dating in its current form is not without its fair share of limitations and problems. Matchmaking overall is nothing new, and many of the problems that face matchmaking online are as old as matchmaking itself. In more recent Internet times, however, the potential scale for matchmaking and social network systems, and the scope of those willing to participate, provides potential opportunities and unique challenges.

Just as problems existed before the Internet, current systems are fraught with both intentional and unintentional abuse. People intentionally submit false pictures of themselves, lie regarding their age or marital status, or alter their profile information to suggest something that they think others will want rather than real facts. Even if the user does not intend to misrepresent the facts, the user's self-image does not always match reality.

A number of dating sites claim to overcome this problem by introducing the idea of compatibility testing, in which they employ various surveys to collect information about participants. The information is then analyzed and compatible matches are suggested. But these systems generally rely on people's self-assessments as well, and also rely on assessments that can be flawed.

Much of the criticisms that are levied against traditional psychological testing, such as the Minnesota Mutliphasic Personality Inventory (MPPI) and the Revised NEO Personality Inventory (NEO PI-R) tests, can be applied to the methods employed in the compatibility testing used in these modem matchmaking systems. Erroneous value judgments made in the information-collecting phase ultimately result in poor results.

### SUMMARY OF INVENTION

Methods and apparatus for a participant response system according to various aspects of the present invention operate in conjunction with an information system and an assessment system. The information system may store selection information in response to a first participant's selection of images from a set of candidate images. The assessment system is responsive to the information system, identifies a correlation between the selection information of the first participant and a set of comparison data.

### BRIEF DESCRIPTION OF THE DRAWING

A more complete understanding of the present invention may be derived by referring to the detailed description and claims when considered in connection with the following illustrative figures. In the following figures, like reference numbers refer to similar elements and steps throughout the figures.

FIG. 1 is a block diagram of a participant response system according to various aspects of the present invention.

FIG. 2 is a flow diagram of a participant response process according to various aspects of the present invention.

FIGS. 3A-D represent potential interfaces showing one, two, three, and four images, respectively.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The following representative descriptions of the present invention generally relate to exemplary embodiments and the inventors' conception of the best mode, and are not intended to limit the scope, applicability or configuration of the invention in any way. Rather, the following description is intended to provide convenient illustrations for implementing various embodiments of the invention. Changes may be made in the function and/or arrangement of any of the elements described in the disclosed exemplary embodiments without departing from the spirit and scope of the invention.

The present invention is described partly in terms of functional components and various processing steps. Such functional components and processing steps may be realized by any number of components, operations, and techniques configured to perform the specified functions and achieve the various results. For example, the present invention may employ various elements, materials, computers, networks, databases, storage systems and media, information gathering techniques and processes, and the like, which may carry out a variety of functions. In addition, although the invention is described in the relationship context, the present invention may be practiced in conjunction with any number of applications, environments, and compatibility processes; the systems described are merely exemplary applications for the invention.

Methods and apparatus according to various aspects of the present invention comprise a participant response system 100 using images to exact responses from participants, such as employees, customers, survey- or test-takers, and the like. The results may then be utilized for any appropriate purpose, such as to identify characteristics of individual participants, identify potential relationships, determine attitudes of a group, or determine a participant's aptitude for a job.

The various elements and aspects of the participant response system 100 may be implemented in any manner, such as via hardware and/or software. In the present embodiment, the participant response system 100 comprises a computer program operating on a remotely accessible computer such that participants may provide data directly to the participant response system 100. The participant response system 100 may be implemented, however, on multiple computers, on a local network, in conjunction with intermediaries for supplying participant responses, or in any other appropriate manner.

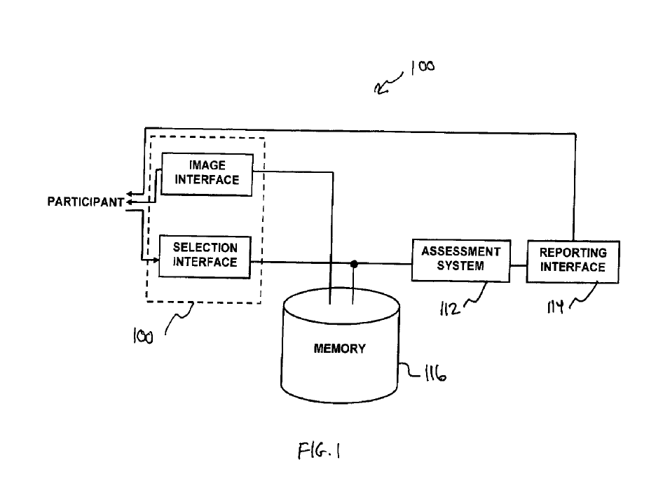

Referring to FIG. 1, in one exemplary embodiment according to various aspects of the present invention, the participant response system 100 includes an information system 110, an assessment system 112, and a reporting interface 114. The information system 110 collects data from the participants, and the assessment system 112 analyzes the collected data. The reporting interface 114 provides conclusions generated by the assessment system 112. Each of the information system 110, assessment system 112, and reporting interface 114 may comprise an aspect or module of a computer program operating on a remote computer accessible via a network, such as the internet or a local area network.

The information system 110 gathers relevant data from the participants, such as by presenting images or other data to the participant and permitting the participant to make selections based on the images or other data. The information system 110 may then store the participant's selections for analysis by the assessment system 112.

In one embodiment, the information system 110 comprises an image interface to provide image data to a participant, such as a program configured to present one or more images to a remote user, for example via the Internet and a display. The information system 110 may present any images, such as random images, images related to assessing a particular personality trait, a preselected sequence of images, and the like. The images may relate to any subject matter, such as people, landscapes, sports, faces, and art. In the present embodiment, the information system 110 presents multiple sets of images, for example in a sequence, to gather the responses of the participant to each set of presented images. The information system 110 may present a series of images in which each set comprises two images presented simultaneously (FIG. 3B). Alternatively, a participant may be required to select from more than two images in each presentation of images (FIGS. 3C-D), or respond to presentation of a single image (FIG. 3A), such as by giving a positive or negative response.

The information system 110 may generate images configured to elicit a participant's reactions to the images to assist in determining like-mindedness of the participant with other participants based, at least in part, on the participants' responses to the images. Alternatively, the information system 110 may generate images configured to identify a habit-of-thought category of the participant or other grouping of the participant based, at least in part, on the participants' responses to the images. In one embodiment, the images are provided with no associated text that may affect the participants' responses. Although text may be included with the images, the text is not associated with the images. For example, the text may include instructions (FIG. 3A), copyright notices, web information, or advertising, but does not include text associated with the images, such as labels or descriptions of the image content, names or locations of items in the images, or characterizations of the content in the images. In one embodiment, the images are accompanied by no text whatsoever (FIG. 3B).

The information system 110 prompts the participant to select an image according to one or more criteria, such as according to which image the participant finds more appealing. The information system 110 may register the participant's selection, for example via a graphic interface, keyboard selection, voice activation, or other appropriate selection interface or system. The information system 110 may permit the user to use a tracking device, touch screen, or mobile or cell phone interface to designate the selected image.

The information system 110 stores the selection made by the participant in a memory 116, such as a conventional data storage system. The selection may be indexed to the individual participant or stored anonymously. In the present embodiment, the selection is associated with identification information of the participant, such as an identification number. After the participant makes a selection, a new set of images is presented to the user. The images may be continually updated, and the field of images may be sufficiently large that duplicate image sets do not occur for individual users, though images may be repeated.

In one embodiment, the information system 110 includes a selection interface, which may comprise a program or other mechanism configured to collect responses based on the participants selecting one or more images among an arrangement of images based on any appropriate criteria, such as personal appeal to the user or impressions of which choice might be better in the view of the user. The selections may be made according to participant preferences based upon their biases related to a given instruction set. Image selection may be one image out of a group based on various criteria, or may involve a selectable range of preference levels among the images in the group. Preferences are not limited to a user liking one image more than others. Preferences may include but are not limited to value judgments, moral questions, closer association with/against, or invocation of feelings such as fear, pride, or happiness.

In another embodiment, the information system 110 may allow participants to add remarks to the images to assist in the assessment process. For example, the participant may provide descriptions of why they selected various images, notes regarding what they viewed as important in the image, or describing the content of the image. Some images may be easy to describe and can be described as a simple noun; others may convey a concept which may elicit a more detailed response.

The information system 110 may also record additional information that may relate to the participants' reactions. For example, the information system 110 may record behavioral information about the user's selections in the selection process, such as the coordinate information tracking where the user actually clicked on an image or the amount of time taken by a user to make selections.

After the participant makes a selection, the user may be given the option to continue or to stop at various intervals based on a number of image selections made or elapsed time. The information system 10 may be configured, however, to collect responses from the participant for any appropriate duration, for any number of images, until the participant elects to quit, or according to any other suitable criteria.

The assessment system 112 analyzes the responses of the participant to generate conclusions. The assessment system 112 may analyze the responses in any suitable manner and for any objective. For example, the assessment system 112 may analyze the responses to determine aspects of the participant's personality, psychology, or perspective. The assessment system 112 may analyze the participant's responses to evaluate potential relationships, business potential, friendships, aptitudes, compatibility, personalities, networking possibilities, like-mindedness, and/or other aspects relating to the participant.

The assessment system 112 may perform any appropriate analysis to generate the conclusions. In one embodiment, the assessment system 112 compares the responses of a particular participant to comparison data. The comparison data may comprise any suitable data to which the participant's data may be compared to make conclusions about the participant. For example, the comparison data may comprise the responses of other participants. High correlations between the selections made by different participants may identify those participants that are like-minded. For example, those who responded similarly to a large percentage of the images may be more like-minded than those who responded more differently. The assessment system 112 may also consider any other relevant information, such as the gender and/or location of the respective participants.

The assessment system 112 may also compare the participant's responses to other comparison data, such as historical information or known patterns, which may provide conclusions relating to the participant. The comparison data may comprise, but are not limited to, historical information, known patterns, participant responses, algorithms and other stored information. The assessment system 112 may then assign the participant to one or more habit-of-thought categories, which may comprise any appropriate characterizations of the participant, such as personality traits, moral perceptions, behavioral tendencies, and the like. For example, the historical information may indicate that previous participants that selected a certain set of images tend to be more solitary and less sociable. If the current participant selected the same set of images, the assessment system 112 may conclude that the current participant is likewise more solitary and less sociable than other participants. The assessment system 112 may also be configured to receive feedback so that the assessment system 112 may apply improved algorithms as additional participants submit answers and results are received from prior analyses.

In one embodiment, the assessment system 112 may accord no weight to the content of the selected images. For example, an image of a tennis ball carries no more weight or meaning than an image of a nuclear blast. The assessment system 112 may correlate the number of similarly selected images to determine which participants are like-minded. In another embodiment, the assessment system 112 may analyze the participant's responses based on other criteria, such as the content of the images, historical data, professional assessment, and industry knowledge. For example, the participants' responses to certain questions may be given greater or lesser weight in determining correlations with other participants' responses or for identifying relevant habit-of-thought categories for the participant.

The reporting interface 114 provides the conclusions and/or the participant's responses. The reporting interface 114 may comprise any output system for providing information, such as a monitor, printer, memory 116, acoustic system, and the like. In addition, the reporting interface 114 may provide any appropriate information. For example, the reporting interface 114 may communicate information relating to other participants identified as like-minded to the participant, and the participant may browse, contact, or make notes on the other participants that have been identified by the assessment system 112 as like-minded and/or satisfying other criteria. In the present embodiment, the reporting interface 114 may provide information regarding other participants that appear to be like-minded based on similarity of the responses provided. In one embodiment, the reporting interface 114 may show information regarding potential matches with other participants or otherwise identify like-minded participants.

The reporting interface 114 may provide additional information, such as a description and/or an interpretation of the results. For example, the reporting interface 114 may provide a listing of the habit-of-thought categories identified by the assessment system 112 for the participant, as well as an explanation of the categories. The reporting interface 114 may provide additional functions, such as allowing exchanges of messages with other participants. For example, the reporting interface 114 may offer an inbox, discussion board, email system, or other communication options. Additionally, participants may make additional personal information available to other participants. Participants may also send invitations to other potential participants via the reporting interface 114.

Additionally, in an alternative embodiment, participants may compare their results to the results of other participants of the system or data regarding various populations. For example, the reporting interface 114 system may report and/or rank the degree of similarity between the participant and one or more participants, groups of participants, or habit-of-thought categories, such as numerically or graphically. In one embodiment, the reporting interface 114 may provide identification information for other participants that appear to be compatible, for example due to a high correlation between the responses provided, as well as a ranking according to the degree of correlation and/or a quantification of the correlation.

In operation, the information system 110 collects selection information from a participant by registering the participant's selections. The assessment system 112 analyzes the selection information to determine characteristics of the participant or otherwise identify correlations to other data. The reporting interface 114 provides conclusions derived from the participant's responses and generated by the assessment system 112.

For example, the participant may initially access the participant response system 100 by accessing a website via the Internet. The information system 110 may collect initial information from the participant, such as contact information, name, gender, age, interests, or other desired information.

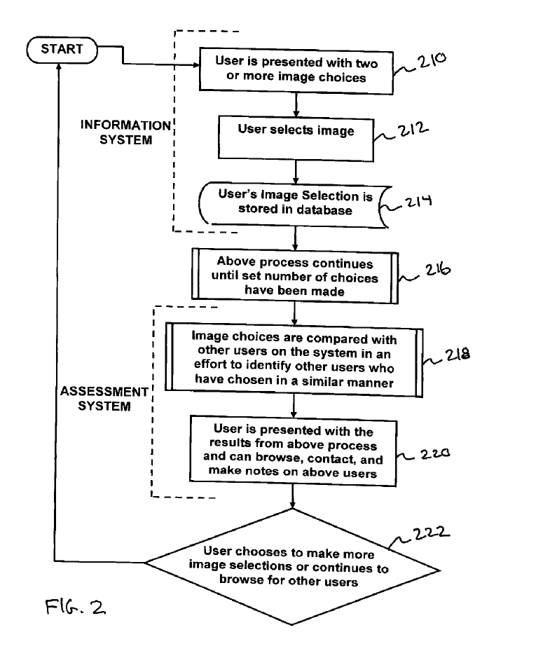

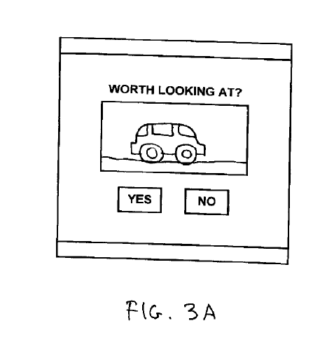

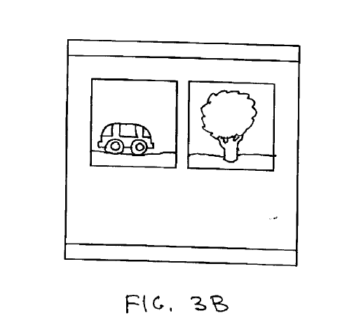

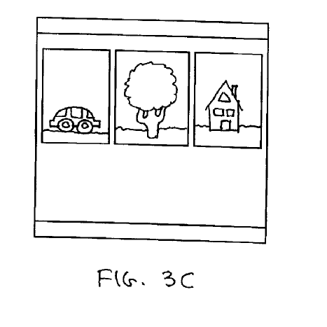

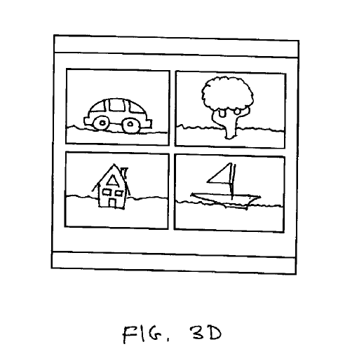

The information system 110 then begins collecting the participant's responses. For example, referring to FIG. 2, the information system 110 may display a selected number of images, such as two images, on the participant's computer (210). The participant selects an image according to any suitable criteria, such as the greater appeal of one image over the other to the participant (212). In the present embodiment, the participant identifies the selection by designating the selected image via the computer. The information system 110 registers the participant's selection and stores the response (214). The information system 110 then provides another set of images to the participant for selection and again stores the response. The information system 110 may repeat the process until a selected number of responses have been received, until the participant elects to terminate the process, or other suitable termination event (216). The information system 110 may also collect any other responses from the participant, such as responses to questions.

The assessment system 112 analyzes the participant's responses to generate the results. In the present embodiment, the assessment system 112 receives the responses from the information system 110 and performs the assessment according to one or more selected algorithms and/or comparison data. For example, the assessment system 112 may compare the participant's responses to the responses of other participants or other data. In the present embodiment, the assessment system 112 correlates the current participant's responses to the responses of other participants to identify participants that made the same or most similar responses as the current participant (218). Those participants that selected the same images or many of the same images may be like-minded. These like-minded individuals may comprise a like-minded grouping. Information on the like-minded participants, such as identification information, may be stored or provided to the reporting interface 114. The assessment system 112 may, however, apply any criteria or algorithm to the responses, such as comparing the responses to historical data or applying different criteria to different sets of responses.

The results generated by the assessment system 112 are received by the reporting interface 114, and the reporting interface 114 provides an output report. For example, the reporting interface 114 may provide information regarding the participants identified by the assessment system 112 as being like-minded. In the present embodiment, the reporting interface 114 provides basic information relating to the identified like-minded participants, such as identification information, contact information, and/or basic biographical information (220). The reporting system may, however, provide any appropriate information.

In the present embodiment, the results may be provided to the participant via a display to aid participants in contacting other like-minded individuals. The reporting interface 114 may also provide other information generated by the assessment system 112, such as conclusions relating to the participant's personality or other habit-of-thought categories. The participants may elect to return to the information system 110 and continue selecting images (222). Participants may also be given the option of selecting from the identical set of images presented to another participant to see how like-minded one is with the other participant. This may be an ongoing process as the other participant selects additional images.

The participant may use the information provided for any purpose.

For example, the participant may wish to contact the other participants identified as being like-minded, such as to initiate possible relationships. The participant may be given the option of reviewing these results or returning to selecting images. In reviewing these results, the participant may be given the option to contact other participants or invite other parties to participate. The information and results may be used for other purposes as well. For example, employers or analysts may use the selection information and results to determine compatibility or aptitude for particular tasks or assignments. The present methods and apparatus provide tools to accommodate the ever-increasing scale and scope of the Internet in helping people to find, identify, and compare with other like-minded individuals online, for whatever purpose, whether to find a lifelong committed partner to an online friend for chat and beyond. Such a tool has useful applications, however, beyond the domain of matchmaking.

In the present specification, the invention is described with reference to specific exemplary embodiments. Various modifications and changes may be made without departing from the scope of the present invention as set forth in the claims. The specification and figures are to be regarded in an illustrative manner, rather than a restrictive one and all such modifications are intended to be included within the scope of the present invention. Accordingly, the scope of the invention should not be limited to merely the examples described above.

For example, the steps recited in any method or process may be executed in any order and are not limited to the specific order presented.

Additionally, the components and/or elements may be assembled or otherwise operationally configured in a variety of permutations to produce substantially the same result as the present invention and are accordingly not limited to the specific configuration recited.

Benefits, other advantages, and solutions to problems have been described with regard to particular embodiments. Any benefit, advantage, solution to problem or any element, however, that may cause any particular benefit, advantage, or solution to occur or to become more pronounced are not to be construed as critical, required or essential features or components.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Furthermore, the terms “first”, “second”, and the like, if any, are used for distinguishing between similar elements and not necessarily for describing a sequential or chronological order. Moreover, the terms “front”, “back”, “top”, “bottom”, “over”, “under”, “forward”, “aft”, and the like, if any, are generally employed for descriptive purposes and not necessarily for comprehensively describing exclusive relative position. Any of the preceding terms so used may be interchanged under appropriate circumstances such that various embodiments of the invention described may be capable of operation in other configurations and/or orientations than those explicitly illustrated or otherwise described.

1. A participant response system for use by multiple participants, comprising:
an information system configured to store selection information in response to a first participant's selection of images from a set of candidate images;
an assessment system responsive to the information system, wherein the assessment system is configured to identify a correlation between the selection information of the first participant and a set of comparison data; and
an output system responsive to the assessment system and configured to generate an output report corresponding to the identified correlation.

2. A participant response system according to claim 1, wherein the information system is further configured to provide the set of candidate images to the first participant.

3. A participant response system according to claim 1, wherein the comparison data comprises selection information corresponding to other participants' selection of images from the set of candidate images.

4. A participant response system according to claim 3, wherein the output report further includes information relating to at least one other participant whose selection information exhibits the correlation to the selection information of the first participant.

5. A participant response system according to claim 1, wherein the comparison data comprises historical data associated with a habit-of-thought category.

6. A participant response system according to claim 1, wherein the information system, the assessment system, and the output system are implemented by a computer program operating on a main computer.

7. A participant response system according to claim 6, wherein the main computer is connected to a remote computer configured to be used by the participant, and wherein the main computer and the remote computer are connected via a network.

8. A participant response system for use by multiple participants, comprising:
an image interface configured to present multiple candidate images without associated text to the multiple participants;
a selection interface responsive to the image interface, wherein the selection interface is configured to receive selection information for each participant corresponding to a set of selected images selected by each participant from the candidate images;
a memory responsive to the selection interface and configured to store the selection information;
an assessment system coupled to the memory, wherein the assessment system is configured to identify correlations between selection information of different participants and a set of comparison data; and
an output system responsive to the assessment system, wherein the output system is configured to report a result according to the identified correlations.

9. A participant response system according to claim 8, wherein the image interface is configured to provide the set of candidate images to the first participant in sets of two simultaneously presented candidate images.

10. A participant response system according to claim 8, wherein the comparison data comprises selection information corresponding to other participants' selection of images from the set of candidate images.

11. A participant response system according to claim 10, wherein the output system is further configured to report information relating to at least one participant whose selection information exhibits the correlation to the selection information of another participant.

12. A participant response system according to claim 8, wherein the comparison data comprises historical data associated with a habit-of-thought category.

13. A participant response system according to claim 8, wherein the image interface, the selection interface, the assessment system, and the output system are implemented by a computer program operating on a main computer.

14. A participant response system according to claim 13, wherein the main computer is connected to a remote computer configured to be used by at least one participant, and wherein the main computer and the remote computer are connected via a network.

15. A computer-implemented method for analyzing information from a participant, comprising:
presenting a set of candidate images to the participant via an image interface;
receiving selection information from the participant, wherein the selection information comprises data corresponding to a set of selected images selected by the participant from the candidate images;
identifying correlations between the selection information of the participant and a set of comparison data; and
generating an output report according to the identified correlations.

16. A method according to claim 15, wherein the comparison data comprises selection information corresponding to other participants' selection of images from the set of candidate images.

17. A method according to claim 16, wherein generating the output report further includes providing information relating to at least one other participant whose selection information exhibits at least one of the identified correlations to the selection information of the first participant in the output report.

18. A method according to claim 15, wherein the comparison data comprises historical data associated with a habit-of-thought category.

19. A method according to claim 18, wherein generating the output report includes providing an identification of the habit-of-thought category in the output report.

20. A method according to claim 15, further comprising:
quantifying the correlation between the selection information of the participant and the set of comparison data to generate a quantification figure; and
providing the quantification figure in the output report.
